(19) United States
(12) Patent Application Publication
(10) Pub. No.: US 2018/0198812 A1
(43) Pub. Date: Jul. 12, 2018

(54) Context-Based Detection of Anomalous Behavior in Network Traffic Patterns

(71) Applicant: QUALCOMM Incorporated, San Diego, CA (US)

(72) Inventors: Mihai Christodorescu, San Jose, CA (US); Shuhua Ge, Fremont, CA (US); Nayeem Islam, Palo Alto, CA (US); Hilmi Gunes Kayacik, San Jose, CA (US)

(21) Appl. No.: 15/403,477

(22) Filed: Jan. 11, 2017

(51) Int. Cl. H04L 29/06; H04L 12/24

(52) U.S. Cl. CPC H04L 63/1425; H04L 41/145

(57) ABSTRACT

Various embodiments provide methods, devices, and non-transitory processor-readable storage media for detecting anomalies in network traffic patterns with a network device by analyzing patterns in network traffic packets traversing the network. Various embodiments include clustering received network traffic packets into groups. The network device receives data packets originating from an endpoint device and analyzes the packets for patterns. The network device may apply a traffic analysis model to the clusters to obtain context classes. The network device may select a behavior classifier model based, at least in part, on the determined context class, and may apply the selected behavior classifier model to determine whether the packet behavior is benign or non-benign.

### BACKGROUND

Some servers and network routers include security software or applications configured to protect a network from various forms of attack. Such network security applications use a variety of methods to identify malware or an attack on the network, and take measures to protect the network when an attack is detected. Network security applications typically rely on two types of detectors for detecting when a network is under attack; negative rule detectors and positive rule detectors.

Negative rule detectors describe types of attacks in the form of a number of rules or tests, and any network traffic that matches a rule is considered an attack and blocked. Positive rule sets describe benign activity and everything that matches a rule is considered benign and allowed. Application servers are highly diverse in terms of complexity, version, and configuration and thus there is wide diversity in potential vulnerabilities. Typical approaches for maintaining rules for network security appliances include creating negative rules for generic attacks, and manually crafting positive rules (e.g., whitelists).

Manually maintaining a network security rule set in an up to date state is time consuming, error prone, and fundamentally reactive instead of proactive. Rules are updated only after attacks are found in the wild so at least one application server or network must fall victim to a new attack before the attack is incorporated into a negative rule set.

### SUMMARY

Various embodiments may include methods, devices for implementing the methods, and non-transitory processor-readable storage media including instructions configured to cause a processor to execute the methods for anomalous behavior detection in network traffic. Various embodiments may include clustering, by a processor of a network device, multiple network traffic packets observed within a network, applying a traffic analysis model to the clusters of network traffic packets to obtain a context class associated with each cluster of network traffic packets, determining whether a behavior of a cluster of network traffic packets is benign or non-benign based, at least in part, on the context class associated with the cluster of network traffic packets, and initiating a network security measure in response to determining that behavior of the cluster of network traffic packets is non-benign. In some embodiments, the context class may be one or more of a user, session, role, group, folder, data item, or work flow.

In some embodiments, the received network traffic packets may originate within the same application of a user computing device. In some embodiments, the network traffic packets may be requests to a server and server responses. In some embodiments, the traffic analysis model may be applied at varying time scales to the clusters of network traffic packets. In some embodiments, the traffic analysis model may be applied based, at least in part, on a hierarchy of the context classes.

In some embodiments, determining whether the behavior of a cluster of network traffic packets is benign or non-benign may include selecting a behavior classifier model for each identified context class, generating a behavior vector from the network traffic packets, and applying the selected behavior classifier model to the generated behavior vector.

Some embodiments may further include calculating an accuracy score for the selected behavior classifier model. Such embodiments may further include calculating an error rate using multiple calculated accuracy scores, determining whether the error rate exceeds an error threshold, and retraining the selected behavior classifier model in response to determining that the error rate exceeds the error threshold.

Further embodiments may include a network device having a network interface and a processor configured with processor-executable instructions to perform operations of the methods summarized above. Further embodiments may include a network device having means for performing functions of the methods summarized above. Further embodiments may include a non-transitory processor-readable storage medium on which is stored processor-executable instructions configured to cause a processor of a communication device to perform operations of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a communications system block diagram of a network suitable for use with various embodiments.

FIG. 2 is a block diagram illustrating a communications device according to various embodiments.

FIG. 3 is a block diagram illustrating a network device according to various embodiments.

FIG. 4 is a block diagram illustrating interactions between a communications device and a network device configured to detect anomalies in network traffic patterns according to various embodiments.

FIG. 5 is a call flow diagram illustrating communications involved in analyzing network traffic patterns according to various embodiments.

FIG. 6 is a process flow diagram illustrating a method for detecting anomalies in network traffic patterns according to various embodiments.

FIG. 7 is a process flow diagram illustrating a method for dynamic error correction of models for detecting anomalies in network traffic patterns according to various embodiments.

FIG. 8 is a component block diagram of a network device suitable for implementing some embodiments.

### DETAILED DESCRIPTION

Various embodiments and implementations will be described in detail with reference to the accompanying drawings. Wherever possible, the same reference numbers will be used throughout the drawings to refer to the same or like parts. References made to particular examples and implementations are for illustrative purposes, and are not intended to limit the scope of the disclosure or the claims.

Various embodiments include methods that may be implemented within a network device to identify non-benign network activities and attacks by monitoring network traffic using a classification model or models that enable dynamic and automated updating. Various embodiments improve network security measures by enabling new threats and attacks to be identified and countered without a first victim and operator actions to identify benign network traffic.

The terms “communications device” and “computing device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor, memory, and circuitry for establishing wireless communications pathways and transmitting/receiving data via a network.

Communications devices, such as mobile communications devices (e.g., smart phones), may use a variety of interface technologies, such as wired interface technologies (e.g., Universal Serial Bus (USB) connections, etc.) and/or air interface technologies (also known as radio access technologies) (e.g., Third Generation (3G), Fourth Generation (4G), Long Term Evolution (LTE), Edge, Bluetooth, Wi-Fi, satellite, etc.). Communications devices may establish connections to a network, such as the Internet, via more than one of these interface technologies at the same time (e.g., simultaneously). For example, a mobile communications device may establish an LTE network connection to the Internet via a cellular tower or a base station at the same time that the mobile communications device may establish a wireless local area network (WLAN) network connection (e.g., a Wi-Fi network connection) to an Internet connected Wi-Fi access point.

The term “network device” is used herein to refer to any computing device that is configure to monitor network traffic, such as communications between an end-user device (e.g., a mobile communications device) and a remote server, (e.g., an application server). Network devices may be stand alone computing devices coupled to a network and configured to monitor network traffic. Network devices may also be implemented as a software application executing within computing devices actively involved in network communication, such as routers, switches, wireless access points, public switched telephone network (PSTN) network hardware, and communications devices acting as a wireless access point for other communications devices (e.g., in an ad-hoc network). Network devices are configured to receive and monitor data packets transmitted by another computing device with or without packet modification.

As used herein, the term “context” refers to descriptions of the application execution environment of an application executing on a communications device. The context may be inferred from network traffic packets as fields within packet headers that remain consistent for a period of time or with respect to other packets.

In overview, the various embodiments provide methods, devices, and non-transitory processor-readable storage media for detecting anomalies in network traffic patterns with a network device by analyzing patterns in network traffic packets traversing the network. Various embodiments include clustering received network traffic packets according to similarities or timing. For example, the network device may receive network traffic packets originating from an application executing on an end-user communications device and analyze the received packets for patterns. The network device may apply a traffic analysis model to the clusters of network traffic packets to obtain one or more context classes associated with each cluster. The context class may be a user, a session, data files, an application, a user group, or any other commonality shared by the received network traffic packets. The network device may select a behavior classifier model based, at least in part, on the obtained context class, and may apply the selected behavior classifier model to the cluster of network traffic packets in order to determine whether the behavior of the cluster of network traffic packets is benign or non-benign (e.g., an attack on the network).

Conventional network anomaly detection schemes typically rely on either positive or negative detection algorithms. Positive detection schemes detect anomalies within network traffic and rely on predefined rules to make decisions as to network traffic that should be allowed. Negative detectors also identify anomalies within network traffic, but use predefined rules to make decisions about the types of network traffic that should be excluded. However, both of these approaches are typically too rigid to accommodate changes in applications, application versions, attack vectors, users, etc. without requiring patching or other time-consuming updating.

Various embodiments provide methods and devices for dynamic training of anomaly detection models using context inferred from applications executing on endpoint devices. Various embodiments look at patterns within network traffic packets, rather than on-device execution metrics, in order to gather information from multiple devices across multiple sessions. The anomaly detection models may infer a context within which an application is executing, and may analyze observed network traffic packets based, at least in part, on the inferred context. This provides performance improvements over conventional methods of analyzing packets individually, or relying on on-device anomaly detection software. As false positives are detected, the anomaly detection models may automatically retrain so as to adapt to changes in packet patterns associated with updates in applications, new users, new applications, or new vectors or methods of attack. Thus, various embodiments may enable a lightweight, autonomously dynamic network anomaly detection model. Over time, the methods may exhibit reduced time needed to identify new threats and thereby improve network security.

In various embodiments, a network device, such as a standalone network monitor or an active network device programmed with a software application according to various embodiments (e.g., network router, application server, or switch) may observe the context characteristics of groups of packets (e.g., packet headers, timing, originator, etc.) traversing the network. The network device may cluster or otherwise group network traffic packets according to time stamp, time dispersion, or other similarities. The network device may then apply a traffic analysis model, such as a statistical model or machine learning model, to the observed context characteristics to determine a context class characterizing the shared context characteristics of the network traffic packets. The context class may be the context within which the application transmitting the packets is executing. The network device may build a behavior vector using the network traffic packets within a given cluster. This behavior vector and a behavior classifier model selected based, at least in part, on the obtained context class may be used as input for a classification scheme that may produce a behavior analysis result indicating whether the observed network traffic packets are benign or non-benign (e.g., a network attack). If the network device determines from this behavior analysis that the observed network traffic is non-benign, the network device may take an action to protect the network, such as issuing an alarm, terminating a network application, isolating one or more computing devices within the network, etc.

In various embodiments, the network device may collect application activity (e.g., network traffic events, organized as requests and responses) in the form of network packets. The network device may group or cluster the network traffic packets according to similarities. The network device may analyze the network traffic packets to extract context characteristics, which may be indicators of context. Based on such context characteristics, the network device may assign one or more context classes to the cluster of network traffic packets. The network device may also analyze clusters of events at varying time scales to extract indicators of context. This process may be repeated in a hierarchical fashion until all traffic is analyzed. This is because certain context classes may have an inherent hierarchy of granularity, and this hierarchy may determine the order of analysis.

In various embodiments, context classes may include (but is not limited to): the user of an application executing on a communications device, a specific session of an application execution; a role of the executing application; a group to which the user or application belongs; a folder upon which the application is operating; a data item in use by the application; and/or a work flow in use by the application. Further examples may include any common characteristic identifying the usage context of an application executing on the endpoint communications device.

For each context class that the network device identifies, the network device may create a machine-learning model (e.g., a behavior classifier model) from the network traffic packets associated with that context. These behavior classifier models may be scored by the network device based on their maturity (e.g., based on an accuracy of classifications produced by the classifier model). The network device may use each behavior classifier model to identify anomalies in observed network packets. Packets that are indicated as being anomalous for multiple behavior classifier models may signal that an attack is occurring.

When anomalies are detected across all behavior classifier models, it is likely that the originating application was modified or updated. The network device may re-start the behavior classifier model training to learn the new “normal” behavior. In some embodiments, the network device may receive feedback in the form of feedback from an administrator, user or analyst that provides correct labels for past events, and use such input in modifying or updating the behavior classifier models to improve accuracy.

Various embodiments thus include techniques for providing network security based on inferred context of observed network traffic packets. In this way, the various embodiments enable network security monitoring without requiring foreknowledge of specific attacks. Various embodiments provide computing devices configured to detect anomalous network traffic by applying a classification model to behavior vectors based on observed network traffic packet characteristics and application context of the network traffic packets. Computing devices configured according to various embodiments may infer contexts automatically by applying statistical analysis and machine learning across many request/response packets within network traffic, such as requests for service from application server and responses by the application server to such requests. Various embodiments provide computing devices configured to enable applying anomaly detection to each inferred contexts of observed network traffic packets. Various embodiments provide computing devices configured to enable autonomous, continuous building of contextual anomaly detectors that adapt to updates in application version, user turnover, and network technology modification. Various embodiments provide computing devices configured to infer application context based on shared characteristics of observed packets

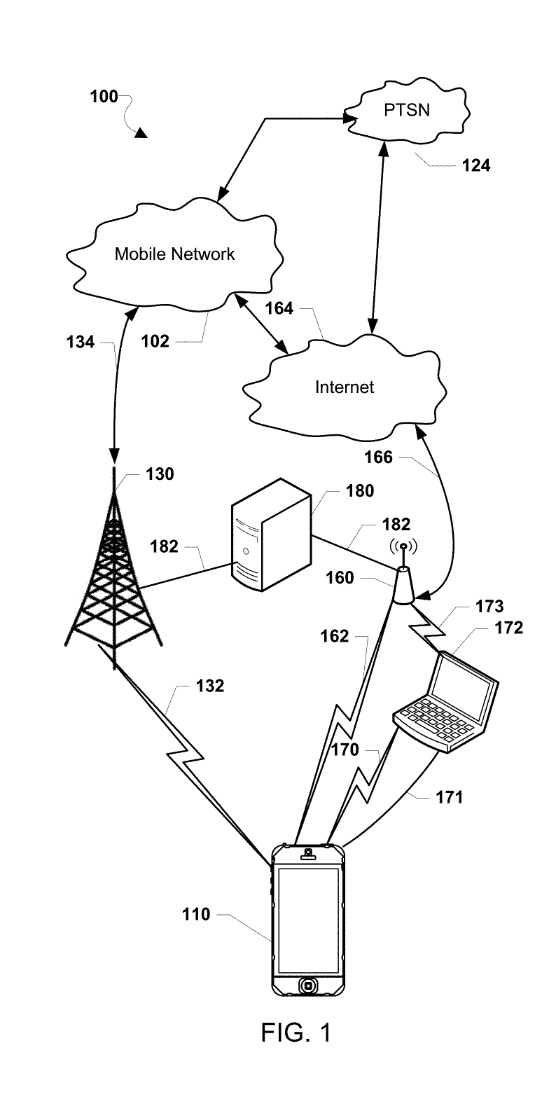

Various embodiments may be implemented within a variety of communications systems 100, an example of which is illustrated in FIG. 1. A mobile network 102 typically includes a plurality of cellular base stations (e.g., a first base station 130. The network 102 may also be referred to by those of skill in the art as access networks, radio access networks, base station subsystems (BSSs), Universal Mobile Telecommunications Systems (UMTS) Terrestrial Radio Access Networks (UTRANs), etc. The network 102 may use the same or different wireless interface technologies and/or physical layers. In an embodiment, the base stations 130 may be controlled by one or more base station controllers (BSCs). Alternate network configurations may also be used and the embodiments are not limited to the configuration illustrated.

A first communications device 110 may be in communications with the mobile network 102 through a cellular connection 132 to the first base station 130. The first base station 130 may be in communications with the mobile network 102 over a wired connection 134.

The cellular connection 132 may be made through two-way wireless communications links, such as Global System for Mobile Communications (GSM), UMTS (e.g., Long Term Evolution (LTE)), Frequency Division Multiple Access (FDMA), Time Division Multiple Access (TDMA), Code Division Multiple Access (CDMA) (e.g., CDMA 1100 1×), WCDMA, Personal Communications (PCS), Third Generation (3G), Fourth Generation (4G), Fifth Generation (5G), or other mobile communications technologies. In various embodiments, the communications device 110 may access network 102 after camping on cells managed by the base station 130.

The network 102 may be interconnected by public switched telephone network (PSTN) 124 and/or the Internet 164, across which the network 102 may route various incoming and outgoing communications to/from the communications device 110.

In some embodiments, the first communications device 110 may establish a wireless connection 162 with a wireless access point 160, such as over a WLAN connection (e.g., a Wi-Fi connection). In some embodiments, the first communications device 110 may establish a wireless connection 170 (e.g., a personal area network connection, such as a Bluetooth connection) and/or wired connection 171 (e.g., a USB connection) with a second communications device 172. The second communications device 172 may be configured to establish a wireless connection 173 with the wireless access point 160, such as over a WLAN connection (e.g., a Wi-Fi connection). The wireless access point 160 may be configured to connect to the Internet 164 or another network over the wired connection 166, such as via one or more modem and router. Incoming and outgoing communications may be routed across the Internet 164 to/from the communications device 110 via the connections 162, 170, and/or 171. In some embodiments, the access point 160 may be configured to run network address translation (NAT) services mapping local network addresses of the first communications device 110 and the second communications device 172 to a public Internet Protocol (IP) address and port prior to routing respective data flows to Internet 164.

Various embodiments may be implemented in software executing within an active network component, such as an access point 160. In such embodiments, embodiments may be implemented as a software module executing within the active network component (e.g., 160) to monitor network packets being handled by the component. Various embodiments may also be implemented in a standard alone computing device, such as a standalone network device 180 configured with software to monitor network packets passing through the network 100. Such a standalone network device 180 may be coupled to one or more active network components (e.g., an access point 160) by a connection 182 by which network packets can be observed

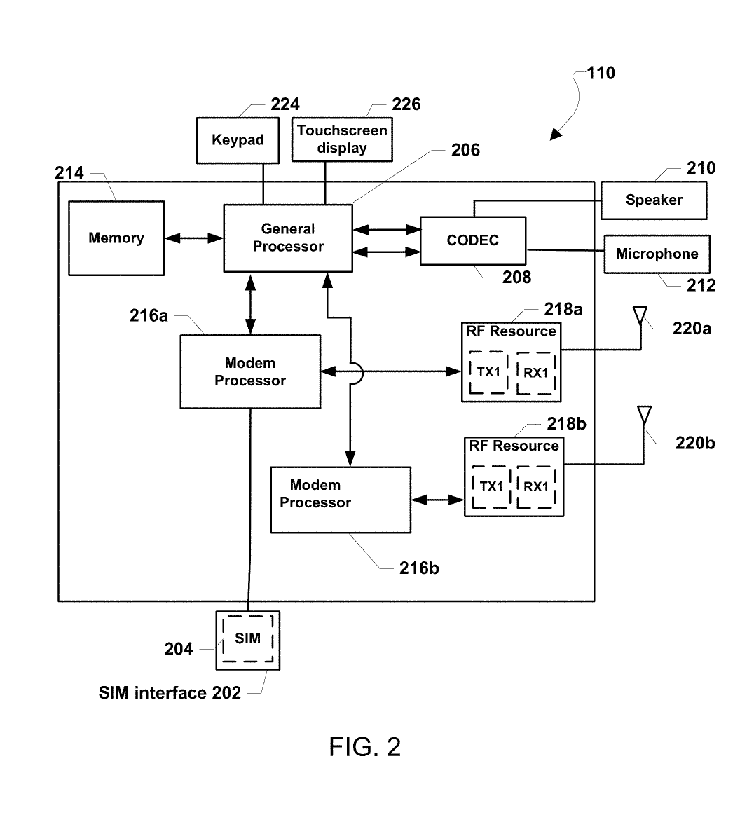

FIG. 2 is a functional block diagram of an example communications device 110 that is suitable for implementing various embodiments. With reference to FIGS. 1-2, the communications device 110 may include a first subscriber identity module (SIM) interface 202, which may receive a subscriber identity module SIM 204 that is associated with a subscription. Some communication devices may have more than one SIM interface to enable multiple SIMs to be installed in the device to enable communications multiple subscriptions

A SIM may be a Universal Integrated Circuit Card (UICC) that is configured with SIM and/or Universal SIM (USIM) applications, enabling access to, for example, GSM, and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM, and I/O circuits.

A SIM used in various embodiments may contain user account information, an international mobile subscriber identity (IMSI), a set of SIM application toolkit (SAT) commands, and storage space for phone book contacts. A SIM card may further store home identifiers (e.g., a System Identification Number (SID)/Network Identification Number (NID) pair, a Home PLMN (HPLMN) code, etc.) to indicate the SIM card network operator provider. An Integrated Circuit Card Identity (ICCID) SIM serial number is printed on the SIM card for identification. However, a SIM may be implemented within a portion of memory of the communications device 110 (e.g., memory 214), and thus need not be a separate or removable circuit, chip or card.

The communications device 110 may include at least one controller, such as a general processor 206, which may be coupled to a coder/decoder (CODEC) 208. The CODEC 208 may in turn be coupled to a speaker 210 and a microphone 212. The general processor 206 may also be coupled to the memory 214. The memory 214 may be a non-transitory computer readable storage medium that stores processor-executable instructions. For example, the instructions may include routing communications data though a corresponding radio frequency (RF) resource chain.

The memory 214 may store an operating system (OS), as well as user application software and executable instructions. The memory 214 may also store application data, such as an array data structure.

The general processor 206 and the memory 214 may each be coupled to at least two modem processors 216a and 216b. A first RF resource chain may include the first modem processor 216a, which may perform baseband/modem functions for communicating with/controlling an interface technology, and may include one or more amplifiers and radios, referred to generally herein as RF resources (e.g., RF resources 218a). The SIM 204 in the communications device 110 may use the first RF resource chain. The RF resource 218a may be coupled to antenna 220a and may perform transmit/receive functions for the wireless services, such as services associated with SIM 204, of the communications device 110. The RF resource 218a may provide separate transmit and receive functionality, or may include a transceiver that combines transmitter and receiver functions. A second RF resource chain may include the second modem processor 216b, which may perform baseband/modem functions for communicating with/controlling an interface technology, and may include one or more amplifiers and radios, referred to generally herein as RF resources (e.g., RF resources 218b). The RF resource 218b may be coupled to antenna 220b and may perform transmit/receive functions for the wireless services of the communications device 110. The RF resource 218b may provide separate transmit and receive functionality, or may include a transceiver that combines transmitter and receiver functions.

In various embodiments, the first RF resource chain including the first modem processor 216a and the second RF resource chain including the second modem processor 216b may be associated with different interface technologies. For example, one RF resource chain may be associated with a cellular air interface technology and the other RF resource chain may be associated with a WLAN technology, such as WiFi. As another example, one RF resource chain may be associated with a cellular air interface technology and the other RF resource chain may be associated with a personal area network (PAN) technology. As another example, one RF resource chain may be associated with a PAN technology and the other RF resource chain may be associated with a WLAN technology. As another example, one RF resource chain may be associated with a cellular air interface technology and the other RF resource chain may be associated with a satellite interface technology. As another example, one RF resource chain may be associated with a WLAN technology and the other RF resource chain may be associated with a satellite air interface technology. Other combinations of different interface technologies, including wired and wireless combinations, may be substituted in the various embodiments, and cellular air interface technologies, WLAN technologies, satellite interface technologies, and PAN technologies are merely used as examples to illustrate aspects of the various embodiments.

In some devices, the general processor 206, the memory 214, the modem processors 216a, 216b, and the RF resources 218a, 218b may be included in the communications device 110 as a system-on-chip. In some devices, the SIM 204 and the corresponding interface 202 may be external to the system-on-chip. Further, various input and output devices may be coupled to components on the system-on-chip, such as interfaces or controllers. Example user input components suitable for use in the communications device 110 may include, but are not limited to, a keypad 224, a touchscreen display 226, and the microphone 212.

In some devices, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. As another example, the request to initiate the outgoing call may be in the form of a voice command received via the microphone 212. Interfaces may be provided between the various software modules and functions in the communications device 110 to enable communications between them. Inputs to the keypad 224, touchscreen display 226, and the microphone 212 discussed above are merely provided as examples of types of inputs that may initiate an outgoing call and/or initiate other actions on the communications device 110. Any other type of input or combinations of inputs may be used in various embodiments to initiate an outgoing call and/or initiate other actions on the communications device 110.

While two RF resource chains including the first modem processor 216a and the second modem processor 216b are illustrated in FIG. 2, additional RF resource chains and additional modem processors may be included in the communications device 110, thereby enabling additional network connections to be made at the same time. Additionally, wired connections may be established via modem processors connected to input/output ports of the communications device 110.

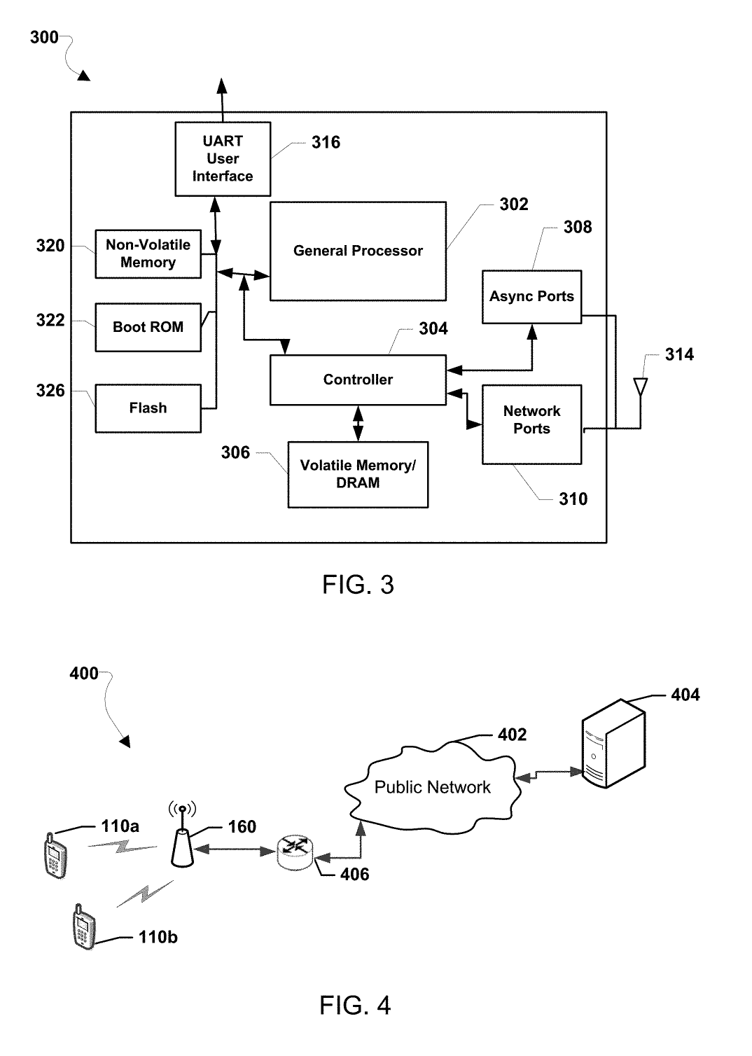

FIG. 3 is a functional block diagram of an example network device 300 that is suitable for implementing various embodiments. With reference to FIGS. 1-3, the network device 300 may be similar to the network device 180, and include multiple network connection interfaces enabling the receipt and transmission of network traffic packets.

In some embodiments, the network device 300 may have similar components and configurations to those described with reference to communications device 110. Network devices may include additional components configured specifically for the routing, mapping, logging, of data packets traversing the network.

The network device 300 may have a general processor 302 coupled to a controller (e.g., system control logic) 304. The controller 304 may be used to help the general processor 302 with network device control, interrupt handling, counting and timing, data transfer, minimal First In, First Out (FIFO) buffering, and communication with network interfaces and volatile memory 308/Dynamic RAM (DRAM). The network device 300 may receive input through a user interface 316. For example, Dual Universal Asynchronous Receiver-Transmitter (UART) may provide the necessary user interface. This may enable the input or receipt of instructions to the network device 300.

The general processor 302 may use buses to access various components of the network device 300. In addition, the buses may be used transferring instructions and data to or from specified memory addresses. This allows communication with Ethernet or Token Ring controllers, wide area network (WAN) port interfaces, and so on. More specifically, the general processor 302 may, via the controller 304 communication with the asynchronous port 308 and network ports (e.g., network interfaces) 310 which may be coupled to an antenna 314. The network device 300 may connect wirelessly, via Ethernet, or any other network connection protocol to other network components and devices.

The network device 300 may have several memories coupled to the general processor 302 and configured for different operations and tasks. Volatile memory/DRAM 306 may have two components including main processor memory, which may be used for routing tables, fast switching cache, running configuration, etc. The volatile memory/DRAM 306 may also include shared I/O memory may be used for temporary storage of packets in system buffers. Flash memory 326 may be a permanent storage for the operating system software images, backup configurations, and any other files.

The general processor 302 may also be coupled to the non-volatile memory 320. The nonvolatile memory 320 may be a non-transitory computer readable storage medium that stores processor-executable instructions. For example, the instructions may include the startup configuration. The boot read-only memory (ROM) 322 may include erasable programmable read-only memory (EPROM) used to permanently store the startup diagnostic code (ROM Monitor), and RxBoot. In some embodiments, the various memories of the network device 300 may be combined into fewer memory components.

FIG. 4 is a network diagram illustrating interactions between a communications device (e.g., the communications device 110 described with reference to FIGS. 1-2) and a network 400 configured to detect anomalous network traffic patterns according to various embodiments. One or more communications devices 110a, 110b may establish a network connection via a network device (e.g., network device 300) such as a WLAN interface technology with one or more access points, such as a wireless access point 160 and router 406.

The communications devices 110a, 110b may be connected to and associated with the wireless access point 160. The wireless access point 160 may be connected to a public network 402, such as the Internet, by a network device, such as router 406. Either or both of the wireless access point 160 and router 406 may be network devices 300 configured to monitor and analyze network traffic packets traversing the network. In some embodiments, in which a communications device is acting as an access point, or in ad-hoc networks, the communications device may be a network device that carries out the operations described herein with reference to a network device 300.

The communications devices 110a, 110b may communicate with a remote server 404 via the connection to the public network 402. Data requests may be sent from the communications devices 110a, 110b to the remote server 404, traversing the wireless access point 160 and router 406 along the way. Similarly, server responses may be transmitted along the network traffic path to the communications devices 110a, 110b. One or more of the wireless access point 160 and the router 406 may observe the requests and responses (i.e., network traffic packets) and analyze the packets for patterns/similarities. Network traffic packets may be grouped according to their similarities and further analyzed to infer a context and a character of the packets.

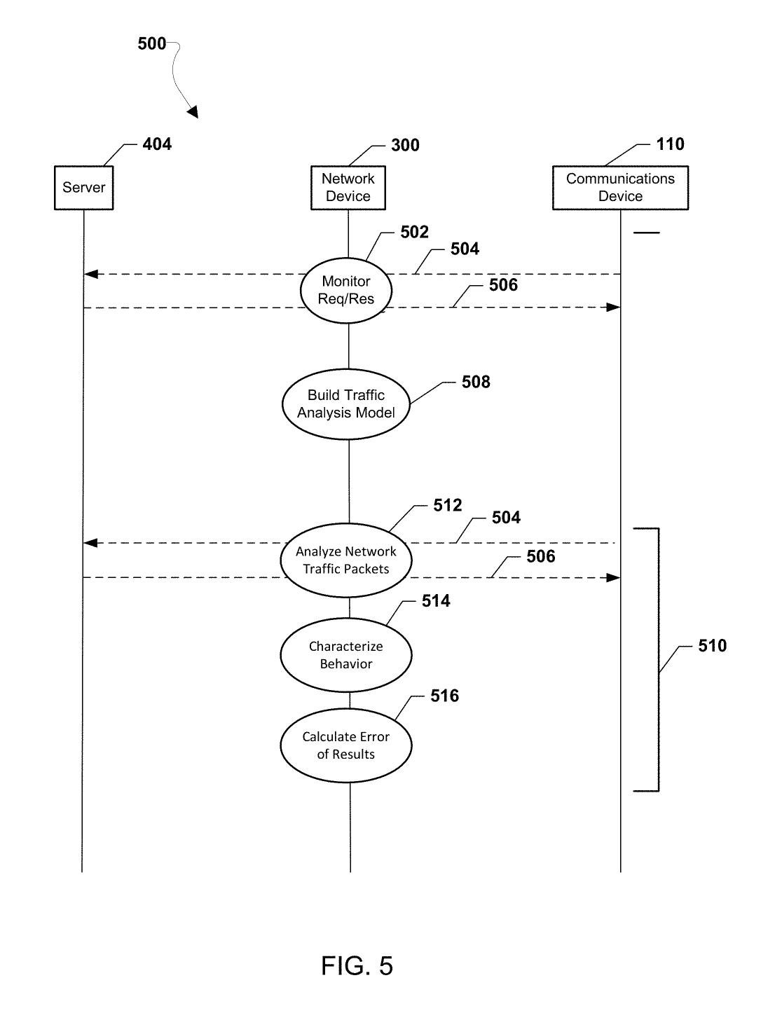

FIG. 5 is a call flow diagram illustrating data flows 500 of network traffic and operations for monitoring network traffic patterns according to various embodiments. With reference to FIGS. 1-5, the data flows 500 may be generated and manipulated with a processor (e.g., the general processor 302, 206, the controller 304, and/or the like) of a network device (e.g., the network device 300, or the communications device 110 described with reference to FIGS. 1-3).

In various embodiments, the communications device 110 may establish a connection with the network device 300 by connecting to a pre-designated access point, an access point offering the strongest RF signal, or the nearest access point to the communications device's physical location. In operations 502, the network device 300 may observe or otherwise monitor network traffic packets 504 traversing the network from the communications device 110 to the server 404, and network traffic packets 506 transmitted by the server 404 to the communications device 110.

In operations 508, the network device 300 may build one or more traffic analysis models based on the network traffic packets observed in the operations 502. The creation of traffic analysis models may involve training of machine-based learning models. The monitoring and observation of network traffic packets may commence without any additional analysis during model training phases. During initial model training, the network device 300 may collect information about packets observed in the operations 502 and store detected patterns in a local storage memory. The network device 300 may observe the network traffic packets both individually and in groups, in order to identify patterns that may indicate a context of an application originating the network traffic packets. This initial context identification is a non-trivial problem because the network device 300 may have no actual knowledge of the applications executing on the communications device 110, and may only rely on inferences resulting from identified patterns in network traffic packets. A further challenge is presented by the changes in network traffic packet patterns that may result from upgrades to a software application, or even changes in user, user group, or session.

In various embodiments, the network device 300 may infer several contexts (i.e., context classes) after a period of observing and monitoring packet headers and packet characteristics of received network traffic packets. This process of building a traffic analysis model in the operation 508 may classify future network traffic packets into one or more context classes. Identified context classes may include, but are not limited to: a current user, the user session, the role of user in the session, a group the user belongs to, a folder image for application, a workflow, and a data item on which the application is acting. Each context class may be inferred based, at least in part, on specific patterns observed in network traffic packets. For example, the current user and user session may be inferred through identified patterns in the packet characteristics of: IP address, hyper text transfer protocol (HTTP) user agent, and request inter-arrival times. In another example, user role within the session and user group may be inferred through identifying patterns in resources accessed (and by comparison against users with known roles). Those identifying the context classes of role and group may require more observation time than user and session, because the ability to identify a user based on observed network traffic packets may be necessary and sufficient for the identification of the user's role within a session. As such, most groups of network traffic packets will have multiple context classes assigned to them. In a further example, the current folder (e.g., location within the communications device 110 file structure), data item, and workflow may be inferred by identifying the packet characteristics of resource type of the folder/URL requested from the server 404.

In various embodiments, the network device 300 may cluster received network traffic packets based on similarities in packet characteristics and timing in order to improve pattern recognition. In various embodiments, the network device 300 may combine context classes of the same logical type such as users of the same group. For example, the network device 300 may identify both a generic “user type” context class, and may also have the context class of “user role” and “specific user”. The context classes thus include both general and specific context classes. This general to specific structure results in a natural hierarchy of context classes. A context class may be a parent to another context class if the parent context class is (mostly) static/invariant for the child context class. Statistical and machine learning models may be used to infer the context classes. Such techniques may utilize invariant detection, causality/correlation analysis, hierarchical clustering on network characteristics, and Text/NLP analytics to infer folder/path.

In some embodiments, the clusters of network traffic packets may be regrouped or reclustered again after context classes are identified. Thus, clusters sharing context classes may be grouped together in order to reduce the number of behavior classifier models needed to analyze the network traffic packets. For example, two clusters having the same role within an application session may be combined to form one larger cluster of network traffic packets, which may be analyzed using some or all of the same behavior classifier models. Regrouping the clusters of network traffic packets may have the benefit of reducing the number of analysis rounds that must be completed, thereby reducing the processing resources needed to complete anomaly detection.

During model generation, the network device 300 may also identify “normal” behavior for each of the context classes. The network device 300 may cluster received network traffic packets into groups or clusters of network traffic packets based, at least in apart on shared packet characteristics of timing (e.g., time between transmissions). The clusters may be generated according to such clustering techniques as k-means clustering, mahalabois distance, or other similarity/center of mass based clustering algorithms.

The network device 300 may apply the traffic analysis model to the clusters of network traffic packets in order to classify the network traffic packets within the cluster as belonging to one or more context classes. The network device 300 may store characteristics of the network traffic packets associated with each context class. Statistical analysis and/or machine learning may be applied to the collected and classified network traffic packet information in order to identify “normal” behavior patterns for each context class. For example, if the network device 300 determines that requesting access to a specific administrative directory on the server 404 is “normal” for members of a particular user group context class, then the network device 300 may “learn” that accessing the folder does not signify malicious behavior if associated with that specific user group context class. However, if other user group context classes do not normally access the administrative folder, then the network device 300 will not characterize the access as normal for those user group context classes.

The network device 300 may use the learned patterns of normal behavior to generate behavior classifier models. The behavior classifier models are specific to each individual context class. For example, there may be a behavior classifier model for each individual user group context class, as well as a generic user group context class behavior classifier model. The behavior classifier models may be vectors or matrices in which each element represents a characteristic of “normal” observed network traffic packet behavior. These behavior classifier models may be stored on the network device 300 and may be updated by retraining the classifier models as the application or its users change. When using the behavior classifier models to characterize behavior as malicious or benign, the network device 300 may take into account the maturity of the behavior classifier models. Maturity of a behavior classifier model may be based, at least in part, on time, the volume of training, etc., or based on accuracy of classifications or changes in accuracy of classifications. The maturity may be represented as a calculated accuracy score that provides a numerical representation of how accurate the behavior classifier model may be in characterizing network traffic packet behavior for a context class.

In operations 510, the network device 300 may use the behavior classifier models to characterize the observed behavior of network traffic packets as malicious or benign. Once the network device 300 has identified a complete set of all possible context classes (e.g., the traffic analysis model is mature), the network device 300 may begin analyzing in operation 512 the request packets 504 and response packets 506 transmitted between the communications device 110 and the server 404.

In operation 514, the network device 300 may cluster the received requests and responses into groups and may apply the traffic analysis model to obtain context classes characterizing each of the clusters of network traffic packets. As part of characterizing behavior in the operation 514, the network device 300 may generate a behavior vector for each context class of each cluster of network traffic packets. The behavior vectors may be vectors of matrices in which the elements represent characteristics of the network traffic packets within the cluster. These behavior vectors may be compared with a corresponding behavior classifier model. For example, a cluster of network traffic packets that has been classified as belonging to the user group of “children” and the session of “multiplayer game” may generate behavior vectors for both context classes, each behavior vector containing packet characteristics and timing information associated with that context class.

Also as part of the characterize behavior operation 514, the network device 300 may compare the “children” behavior vector with a stored “children use group” behavior classifier model in order to determine if the behavior exhibited by the cluster of network traffic packets classified as “children” is benign or malicious. In some embodiments, there may be a threshold acceptable disparity between the behavior classifier model and the behavior vector. Exceeding this threshold may result in the behavior being characterized as malicious. In some embodiments, the comparison may be weighted on an element-by-element basis. For example, particular elements of high importance may signal by malicious behavior if they differ at all from the behavior classifier model.

In various embodiments, the network device 300 may assess the results of the behavior characterization in order to detect false alarms in operation 516. A challenge of network based anomaly detection is that anomalies may occur when behavior is malicious, or simply when underlying applications change. In order to protect against false alarms, the network device 300 may observe the results of the behavior characterization across all applicable context classes. If anomalies are detected locally, across a few context classes, then it is likely that malicious behavior is occurring. However, if anomalies are detected globally, across all context classes, then it is likely that the application, user, or user session has changed dramatically and the detected anomalies are false alarms in such a case. When false alarms are detected, the accuracy score of behavior classifier models may be recalculated or modified and classifier model retraining may be initiated.

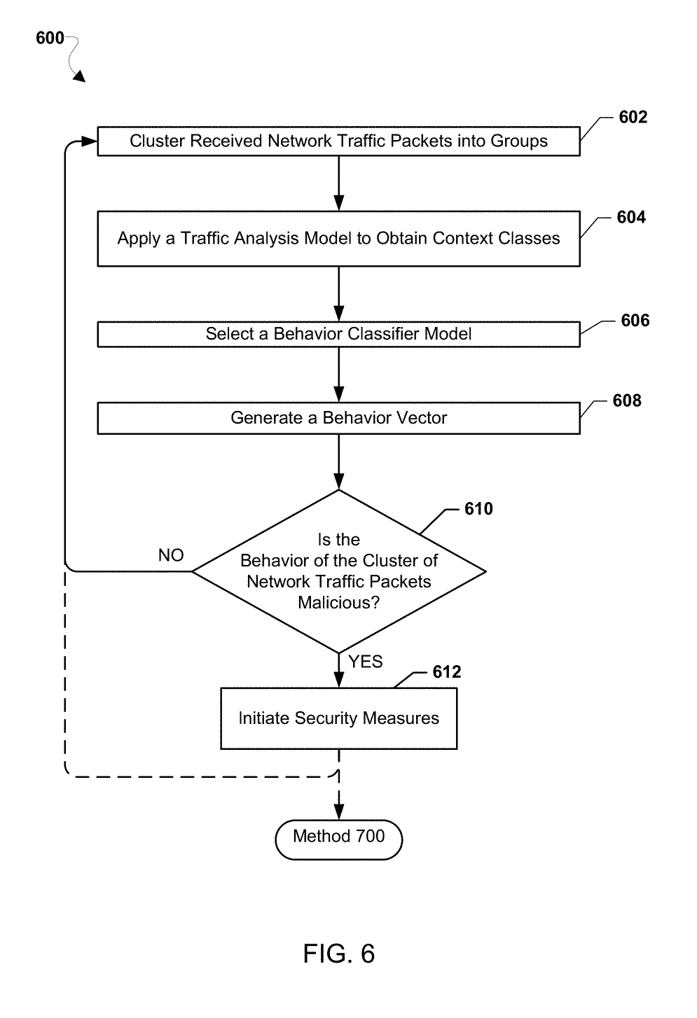

FIG. 6 illustrates a method 600 for detecting anomalies in network traffic patterns according to various embodiments. With reference to FIGS. 1-6, the method 600 may be executed within a processor (e.g., the general processor 302, 206, the controller 304, and/or the like) of a network device (e.g., the network device 300).

In block 602, a processor of the network device may cluster network traffic packets received by a transceiver of the network device. The network device may employ one or more clustering algorithms to organize the received network traffic packets into multiple clusters or groups. The network device may observe similar characteristics in packet header contents, transmission characteristics, or timing of different packets, and may cluster packets with similar characteristics together.

In block 604, the processor may apply a traffic analysis model to the clusters of network traffic packets to obtain a context class associated with each cluster of network traffic packets. The traffic analysis model may be a trained machine learning or statistical analysis model that classifies the cluster of network traffic packets as belonging to one or more context classes. Each context class may be a description of an aspect of an executing application on an endpoint device (e.g., the endpoint device that transmitted the network traffic packets within the cluster). The cluster may be assigned multiple context classes according to how the packet characteristics of the cluster are classified. Such context classes may include the application user(s), a group the user(s) belongs to, the role of the user(s) within a session, the session of the application, relevant workflow, data items in use, and accessed folders.

In block 606, the processor may select a behavior classifier model based, at least in part, on the determined context class. The network device processor may select a stored behavior classifier model for each of the obtained context classes. The behavior classifier models may be specific to each context class and, therefore, a number of behavior classifier models may be selected for each cluster of network traffic packets that is queued for behavior analysis.

In block 608, the processor may generate a behavior vector. The network device processor may collect characteristics of the network traffic packets within the cluster that pertain to each individual context class and generate a behavior vector for each context class. Alternatively, the network device processor may generate a single behavior vector that contains all packet characteristics, timing information, and transmission characteristics associated with the network traffic packets within the cluster.

In determination block 610, the processor may determine whether behavior of a cluster of network traffic packets is malicious based, at least in part, on the context class associated with the cluster of network traffic packets. The network device processor may compare the selected behavior classifier model(s) to the behavior vector(s) in order to determine whether the observed behaviors are benign or non-benign (e.g., associated with a network attack).

In response to determining that the behavior of the cluster of network traffic packets is benign (i.e., determination block 610=“NO”), the processor may continue monitoring and clustering received network traffic packets in block 602.

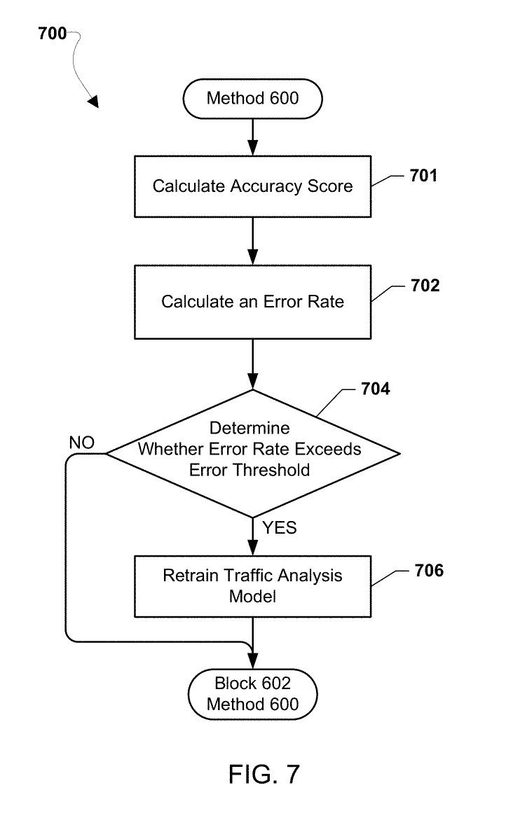

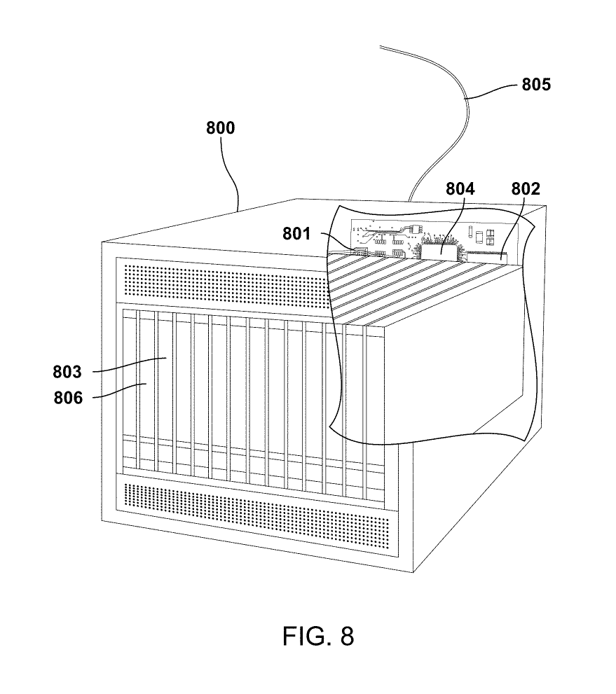

In response to determining that the behavior of the cluster of network traffic packets is not benign (i.e., determination block 610=“YES”), the processor may initiate network security measures in block 612. Non-limiting examples of network security measures that may be implemented in block 612 include issuing an alert or alarm to a network complement or operator, suspending an application (e.g., a client/server application), isolating one or more network components, filtering or otherwise limiting network traffic, etc. The processor may also continue monitoring and clustering received network traffic packets in block 602 and/or perform dynamic error correction of models for detecting anomalies in network traffic patterns in method 700 as illustrated in FIG. 7.

FIG. 7 illustrates a process flow diagram of a method 700 for dynamic error correction of models for detecting anomalies in network traffic patterns to various embodiments. With reference to FIGS. 1-7, the method 700 may be generated and manipulated with a processor (e.g., the general processor 302, 206, the controller 304, and/or the like) of a network device (e.g., the network device 300 or the communications device 110 described with reference to FIGS. 1-3).

In block 701, a processor of the network device may calculate an accuracy score for each behavior classifier model applied in the determination of whether the behavior is malicious in determination block 614 of the method 600. The accuracy score may be computed based, at least in part, on a one-time evaluation of labeled network traffic packets done before deployment. This base measurement may be based on a continuous learning mechanism that takes into account feedback from a security analyst for generated alerts, or any hybrid combination of such approaches.

In block 702, the processor may calculate an error rate using multiple accuracy scores. For example, the network device may calculate the accuracy scores for multiple behavior classifier models during an analysis session and may aggregate these accuracy scores to obtain an error rate. The error rate may indicate the number of behavior classifier models that produced malicious behavior results during behavior analysis.

In determination block 704, the processor may determine whether the calculated error rate exceeds an error threshold. The network device may compare the calculated error rate to a predetermined or moving target threshold in order to determine whether the error rate exceeds the threshold. If the error rate exceeds the threshold, it may indicate that malicious behavior has been detected globally rather than locally, and that the detected anomalous behavior is attributable to a change in software application or user rather than malicious behavior.

In response to determining that the calculated error rate does not exceed an error threshold (i.e., determination block 704=“NO”), the processor may continue clustering received network traffic packets into groups for behavior analysis in block 602 of the method 600 as described.

In response to determining that the calculated error rate exceeds an error threshold (i.e., determination block 704=“YES”), the processor may retrain the behavior classifier model in block 706. If a global anomaly event is detected, the network device may assume that the originating software application or user has changed and that retraining of all relevant behavior classifier models is needed. The network device may begin monitoring and observation of received network traffic packets in order to detect any new context classes and relearn “normal” behavior patterns in block 706. Thereafter, the processor may continue clustering received network traffic packets into groups for behavior analysis using the retrain traffic analysis model in block 602 of the method 600 as described.

Various embodiments may be implemented in any of a variety of network devices, an example on which in the form of a server 800 is illustrated in FIG. 8. With reference to FIGS. 1-8, the network device 800 may be similar to the network device 180, 300, and may implement the method 500, the method 600, and/or the method 700 as described.

Such a server 800 typically includes a processor 801 coupled to volatile memory 802 and a large capacity nonvolatile memory, such as a disk drive 803. The server 800 may also include a floppy disc drive, compact disc (CD) or digital versatile disc (DVD) disc drive 806 coupled to the processor 801. The server 800 may also include network access ports 804 coupled to the processor 801 for establishing data connections with a network 805, such as a local area network coupled to other broadcast system computers and servers.

The processor 801 may be any programmable microprocessor, microcomputer or multiple processor chip or chips that can be configured by software instructions (applications) to perform a variety of functions, including the functions of the various embodiments described above. In some embodiments, multiple processors may be provided, such as one processor dedicated to wireless communication functions and one processor dedicated to running other applications. Typically, software applications may be stored in the internal memory 802, 803 before they are accessed and loaded into the processor 801. The processor 801 may include internal memory sufficient to store the application software instructions.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a variety of processors. Examples of suitable processors include, for example, a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the various embodiments. Various modifications to these embodiments will be readily apparent to those skilled in the art, and the generic principles defined herein may be applied to some embodiments without departing from the scope of the claims. Thus, the present disclosure is not intended to be limited to the examples shown herein but is to be accorded the widest scope consistent with the following claims and the principles and novel features disclosed herein.

What is claimed is:

1. A method of detecting anomalous behavior in network traffic, comprising:
clustering, by a processor of a network device, network traffic packets observed within a network;
applying a traffic analysis model to the clusters of network traffic packets to obtain a context class associated with each cluster of network traffic packets;
determining whether a behavior of a cluster of network traffic packets is benign or non-benign based, at least in part, on the context class associated with the cluster of network traffic packets; and
initiating a network security measure in response to determining that the behavior of the cluster of network traffic packets is non-benign.

2. The method of claim 1, wherein the context class is one or more of a user, session, role, group, folder, data item, or work flow.

3. The method of claim 1, wherein the received network traffic packets originate within the same application of a user computing device.

4. The method of claim 1, wherein the network traffic packets are requests to a server and server responses.

5. The method of claim 1, wherein applying the traffic analysis model to the clusters of network traffic packets comprises applying the traffic analysis model to the clusters of network traffic packets at varying time scales to the clusters of network traffic packets.

6. The method of claim 1, wherein applying the traffic analysis model to the clusters of network traffic packets comprises applying the traffic analysis model to the clusters of network traffic packets based, at least in part, on a hierarchy of the context classes.

7. The method of claim 1, wherein determining whether the behavior of a cluster of network traffic packets is benign or non-benign further comprises:
selecting a behavior classifier model for each identified context class;
generating a behavior vector from the network traffic packets; and
applying the selected behavior classifier model to the generated behavior vector.

8. The method of claim 7, further comprising calculating an accuracy score for the selected behavior classifier model.

9. The method of claim 7, further comprising:
calculating an error rate using multiple calculated accuracy scores;
determining whether the error rate exceeds an error threshold; and
retraining the selected behavior classifier model in response to determining that the error rate exceeds the error threshold.

10. The method of claim 1, wherein the network device is a router.

11. A network device for detecting anomalous behavior in network traffic, comprising:
a network interface; and
a processor coupled to the network interface and configured with processor-executable instructions to:
cluster network traffic packets observed within a network;
apply a traffic analysis model to the clusters of network traffic packets to obtain a context class associated with each cluster of network traffic packets;
determine whether a behavior of a cluster of network traffic packets is benign or non-benign based, at least in part, on the context class associated with the cluster of network traffic packets; and
initiate a network security measure in response to determining that the behavior of the cluster of network traffic packets is non-benign.

12. The network device of claim 11, wherein the context class is one or more of a user, session, role, group, folder, data item, or work flow.

13. The network device of claim 11, wherein the received network traffic packets originate within the same application of a user computing device.

14. The network device of claim 11, wherein the network traffic packets are requests to a server and server responses.

15. The network device of claim 11, wherein the processor is further configured with processor-executable instructions to apply the traffic analysis model to the clusters of network traffic packets at varying time scales to the clusters of network traffic packets.

16. The network device of claim 11, wherein the processor is further configured with processor-executable instructions to apply the traffic analysis model to the clusters of network traffic packets based, at least in part, on a hierarchy of the context classes.

17. The network device of claim 11, wherein the processor is further configured with processor-executable instructions to determine whether the behavior of a cluster of network traffic packets is benign or non-benign by:
selecting a behavior classifier model for each identified context class;
generating a behavior vector from the network traffic packets; and
applying the selected behavior classifier model to the generated behavior vector.

18. The network device of claim 17, wherein the processor is further configured with processor-executable instructions to calculate an accuracy score for the selected behavior classifier model.

19. The network device of claim 17, wherein the processor is further configured with processor-executable instructions to:
calculate an error rate using multiple calculated accuracy scores;
determine whether the error rate exceeds an error threshold; and
retrain the selected behavior classifier model in response to determining that the error rate exceeds the error threshold.

20. The network device of claim 11, wherein the network device is a router.

21. A non-transitory processor-readable media having stored thereon processor-executable instructions configured to cause a processor of a network device to perform operations for detecting anomalous behavior in network traffic, comprising:
clustering, by a processor of a network device, network traffic packets observed within a network;
applying a traffic analysis model to the clusters of network traffic packets to obtain a context class associated with each cluster of network traffic packets;
determining whether a behavior of a cluster of network traffic packets is benign or non-benign based, at least in part, on the context class associated with the cluster of network traffic packets; and
initiating a network security measure in response to determining that the behavior of the cluster of network traffic packets is non-benign.

22. The non-transitory processor-readable media of claim 21, wherein the context class is one or more of a user, session, role, group, folder, data item, or work flow.

23. The non-transitory processor-readable media of claim 21, wherein the received network traffic packets originate within the same application of a user computing device.

24. The non-transitory processor-readable media of claim 21, wherein the network traffic packets are requests to a server and server responses.

25. The non-transitory processor-readable media of claim 21, wherein the stored processor-executable instructions are configured to cause the processor of the network device to perform operations such that applying the traffic analysis model to the clusters of network traffic packets comprises applying the traffic analysis model at varying time scales to the clusters of network traffic packets.

26. The non-transitory processor-readable media of claim 21, wherein the stored processor-executable instructions are configured to cause the processor of the network device to perform operations such that applying the traffic analysis model to the clusters of network traffic packets comprises applying the traffic analysis model based, at least in part, on a hierarchy of the context classes.

27. The non-transitory processor-readable media of claim 21, wherein the stored processor-executable instructions are configured to cause the processor of the network device to perform operations such that determining whether the behavior of a cluster of network traffic packets is benign or non-benign comprises:
selecting a behavior classifier model for each identified context class;
generating a behavior vector from the network traffic packets; and
applying the selected behavior classifier model to the generated behavior vector.

28. The non-transitory processor-readable media of claim 27, further comprising calculating an accuracy score for the selected behavior classifier model.

29. The non-transitory processor-readable media of claim 27, wherein the stored processor-executable instructions are configured to cause the processor of the network device to perform operations further comprising:
calculating an error rate using multiple calculated accuracy scores;
determining whether the error rate exceeds an error threshold; and
retraining the selected behavior classifier model in response to determining that the error rate exceeds the error threshold.

30. A network device for detecting anomalous behavior in network traffic, comprising:
means for clustering network traffic packets observed within a network;
means for applying a traffic analysis model to the clusters of network traffic packets to obtain a context class associated with each cluster of network traffic packets;
means for determining whether a behavior of a cluster of network traffic packets is benign or non-benign based, at least in part, on the context class associated with the cluster of network traffic packets; and
means for initiating a network security measure in response to determining that the behavior of the cluster of network traffic packets is non-benign.
